(19) United States
(12) Patent Application Publication
(10) Pub. No.: US 2019/0036843 A1
(43) Pub. Date: Jan. 31, 2019

(54) INTER-SWITCH COMMUNICATION MANAGEMENT APPARATUS, INTER-SWITCH COMMUNICATION MANAGEMENT METHOD, AND COMPUTER-READABLE STORAGE MEDIUM

(71) Applicant: HITACHI, LTD., Tokyo (JP)

(72) Inventors: Tomoaki KAKEDA, Tokyo (JP); Kiminori SUGAUCHI, Tokyo (JP)

(73) Assignee: HITACHI, LTD., Tokyo (JP)

(21) Appl. No.: 16/085,777

(22) PCT Filed: Jun. 30, 2016
(86) PCT No.: PCT/JP2016/069559

§ 371 Date: Sep. 17, 2018

(51) Int. Cl. H04L 12/933; H04L 12/46; H04L 5/00

(52) U.S. Cl. CPC H04L 49/15; H04L 5/0058; H04L 12/4641

(57) ABSTRACT

An inter-switch communication management apparatus for allocating communication bands of inter-switch connections in accordance with priorities is provided. An inter-switch communication management apparatus 200 includes: a virtual network request receiving unit that receives an addition or change of a virtual network as a request with a priority; an inter-switch communication band allocation unit that allocates a communication band to be preferentially used to an inter-switch communication band of a connection between two switches in descending order of the priority of virtual networks; and a switch setting unit that sets the allocated communication band to the connection between the two switches.

### TECHNICAL FIELD

The present invention relates to an inter-switch communication management apparatus, an inter-switch communication management method, and a computer-readable storage medium and is suited for use in a network system to which a plurality of computer devices are connected.

### BACKGROUND ART

There has been a widespread of systems for providing various information via a server apparatus connected to a network. Generally, such server apparatus as well as other server apparatuses are connected to switches and are connected to, for example, other networks and storage apparatuses via the switches. Under this circumstance, regarding a communication band of the server apparatus and a communication band of each inter-switch connection, the communication band of each inter-switch connection may sometimes be narrower; and for example, so-called LAG (Link Aggregation) is used between the switches and a plurality of circuits (communication ports) between the switches are bound into one set and are used and shared by a plurality of virtual networks, so that the communication bands of the inter-switch connections are thereby used efficiently.

PTL 1 discloses a communication apparatus including: a traffic monitoring unit that monitors a the traffic volume; a traffic management unit that calculates the number of ports that are necessary communication ports for link aggregation on the basis of the monitoring result of the traffic volume; a device cooperation control unit that generates setting information of communication ports constituting link aggregation and communication paths of the communication apparatus constituting a network on the basis of the number of ports that are the communication ports; and a control packet transmission/reception unit that transmits a control packet including the setting information to the communication apparatus. PTL 2 discloses a dynamic channel path management program for dynamically changing a channel path configuration when use frequency of a certain channel path or a certain I/O device exceeds a predetermined threshold value.

### CITATION LIST

### Patent Literature

PTL 1: Japanese Patent Application Laid-Open (Kokai) Publication No. 2015-056836
PTL 2: Japanese Patent No. 2502467

### SUMMARY OF INVENTION

### Technical Problem

However, a communication band width of an actual inter-switch connection is limited, so that a change in the number of ports for a certain LAG may sometimes affect other LAGs. For example, when a plurality of LAGs are set to a certain switch, an increase in the traffic volume to a certain LAG causes an increase in the number of ports on that LAG, which may thereby sometimes cause a decrease in the number of ports that can be used by other LAGs. As a result, if the suppressed LAGs are used for communication of control data used to control data and server apparatuses which are to be used for applications, sufficient communication bands may not sometimes be secured. Accordingly, since the communication bandwidth of switches is limited, there is a request for uses for a plurality of purposes, other than efficient operation by using the LAGs, in consideration of the importance of the purpose to use the network.

The present invention was devised in consideration of the above-described circumstances and aims at providing an inter-switch communication management apparatus, inter-switch communication management method, and computer-readable storage medium for allocating communication bands of inter-switch connections in accordance with priorities.

### Solution to Problem

In order to solve such problems, an inter-switch communication management apparatus according to the present disclosure includes: a virtual network request receiving unit that receives an addition or change of a virtual network as a request with a priority; an inter-switch communication band allocation unit that allocates a communication band to be preferentially used to an inter-switch communication band of a connection between two switches in descending order of the priority of virtual networks; and a switch setting unit that sets the allocated communication band to the connection between the two switches.

Furthermore, an inter-switch communication management method according to the present disclosure comprises: receiving an addition or change of a virtual network as a request with a priority; allocating a communication band to be preferentially used to an inter-switch communication band of a connection between two switches in descending order of the priority of virtual networks; and setting the allocated communication band to the connection between the two switches.

Furthermore, a computer-readable storage medium according to the present disclosure has a program recorded therein for executing: a virtual network request receiving step of receiving an addition or change of a virtual network as a request with a priority; an inter-switch communication band allocation step of allocating a communication band to be preferentially used to an inter-switch communication band of a connection between two switches in descending order of the priority of virtual networks; and a switch setting step of setting the allocated communication band to the connection between the two switches.

### Advantageous Effects of Invention

When the inter-switch communication management apparatus, the inter-switch communication management method, and the computer-readable storage medium according to the present disclosure are used, communication bands of inter-switch connections can be allocated in accordance with priorities.

### BRIEF DESCRIPTION OF DRAWINGS

FIG. 1 is a diagram schematically illustrating a server network system according to an embodiment of the present disclosure;

FIG. 2 is a diagram illustrating a hardware configuration of an inter-switch communication management apparatus;

FIG. 3 is a diagram illustrating functional blocks of the inter-switch communication management apparatus;

FIG. 4 is a flowchart illustrating an example of virtual network request reception processing;

FIG. 5 is a diagram illustrating an example of a user request table;

FIG. 6 is a diagram illustrating an example of a request input screen;

FIG. 7 is a diagram illustrating an example of a menu definition table;

FIG. 8 is a flowchart illustrating an example of inter-switch communication band allocation processing;

FIG. 9 is a diagram illustrating an example of a switch table;

FIG. 10 is a diagram illustrating an example of an inter-switch port table;

FIG. 11 is a diagram illustrating an example of an inter-switch setting table;

FIG. 12 is a flowchart illustrating an example of first communication band allocation processing;

FIG. 13 is a diagram illustrating an example of the inter-switch setting table updated by an inter-switch communication band allocation unit;

FIG. 14 is a flowchart illustrating an example of second communication band allocation processing; and

FIG. 15 is a flowchart illustrating an example of switch setting processing.

### DESCRIPTION OF EMBODIMENTS

An embodiment according to the present disclosure will be described below in detail with reference to the drawings. In the following description, the same reference numeral is assigned to similar elements and any duplicate explanation is omitted.

### (1) Configuration of Server Network System 100 According to this Embodiment

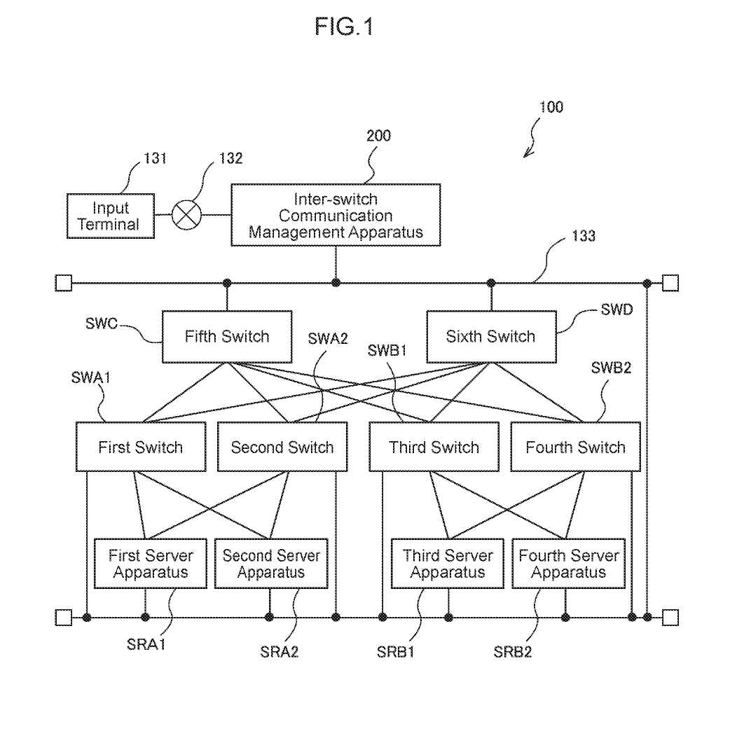

FIG. 1 is a diagram schematically illustrating a server network system 100 according to an embodiment of the present disclosure. Referring to this diagram, the server network system 100 includes: a first server apparatus SRA1, a second server apparatus SRA2, a third server apparatus SRB1, and a fourth server apparatus SRB2; a first switch SWA1, a second switch SWA2, a third switch SWB1, a fourth switch SWB2, a fifth switch SWC, and a sixth switch SWD; an inter-switch communication management apparatus 200; and an input terminal 13 connected to the inter-switch communication management apparatus 200 via a network 132. Under this circumstance, it is assumed that the first server apparatus SRA1 and the second server apparatus SRA2 are managed by user A and the third server apparatus SRB1 and the fourth server apparatus SRB2 are managed by user B. The first switch SWA1 is connected to both the first server apparatus SRA1 and the second server apparatus SRA2 and further to both the fifth switch SWC and the sixth switch SWD. Furthermore, the second switch SWA2 is similarly connected directly to both the first server apparatus SRA1 and the second server apparatus SRA2 and is further connected to both the fifth switch SWC and the sixth switch. The third switch SWB1 is connected to both the third server apparatus SRB1 and the fourth server apparatus SRB2 and is further connected to both the fifth switch SWC and the sixth switch SWD. Furthermore, the fourth switch SWB2 is similarly connected to both the third server apparatus SRB1 and the fourth server apparatus SRB2 and is further connected to the fifth switch SWC and the sixth switch SWD. Furthermore, the first server apparatus SRA1 to the fourth server apparatus SRB2, the first switch SWA1 to the sixth switch SWD, and the inter-switch communication management apparatus 200 are respectively connected to a network 133. The first switch SWA1 to the sixth switch SWD are equipment designed so that after receiving data which has been transmitted from any one of them, the relevant switch transfers the data to another equipment which is connected to deliver the data to an IP address designated as a transmission destination.

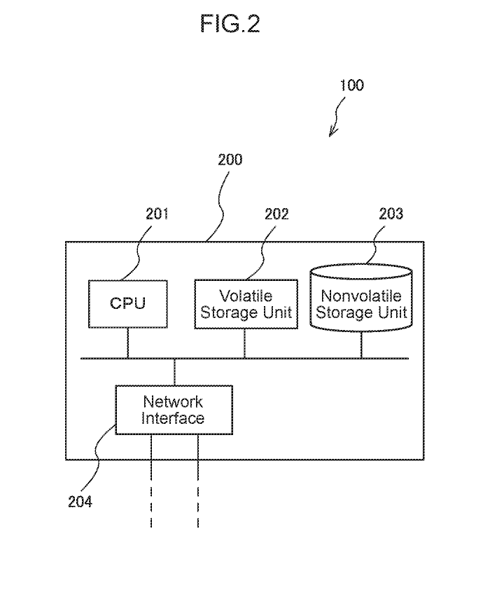

FIG. 2 is a diagram illustrating an example of a hardware configuration of the inter-switch communication management apparatus 200 according to this embodiment. Referring to this drawing, the inter-switch communication management apparatus 200 can be configured of a CPU (Central Processing Unit) 201, a volatile storage unit 202 such as a RAM (Random Access Memory), a nonvolatile storage unit 203 such as a hard disk or a flash memory, and a network interface 204 for connection to the networks 132 and 133. These pieces of hardware can cooperate with software, which is information stored in each storage device, to execute processing of the information. Incidentally, the inter-switch communication management apparatus 200 may be implemented by a computer system to which a plurality of computer devices with the hardware configuration as illustrated in FIG. 2 are connected via a network.

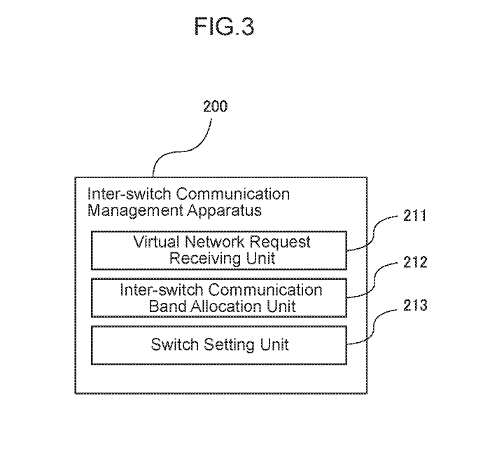

FIG. 3 is a diagram illustrating functional blocks implemented by the hardware of the inter-switch communication management apparatus 200 in FIG. 2 and the software stored in each storage device. Referring to this drawing, the inter-switch communication management apparatus 200 includes: a virtual network request receiving unit 211 that receives an addition or change of a virtual network as a request with a priority; an inter-switch communication band allocation unit 212 that selects the priority in its descending order and allocates a communication band to be used by a virtual network(s) with the selected priority to an inter-switch communication band of a connection between two switches; and a switch setting unit 213 that sets the allocated communication band to the connection between the two switches. In this embodiment under this circumstance, a virtual network may be constructed between at least any ones of the first server apparatus SRA1 to the fourth server apparatus SRB2 and a request to add or change the virtual network may be received from the input terminal 131 via the network 132. Furthermore, a communication band to be used by the virtual network can be allocated to at least a communication band of a connection between two switches from among the first switch SWA1 to the sixth switch SWD.

### (2) Processing of Inter-Switch Communication Management Apparatus

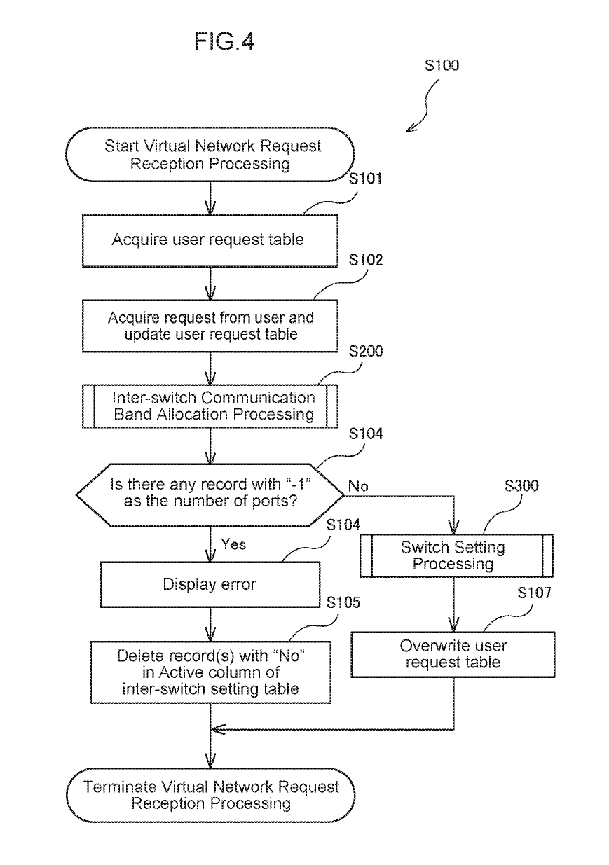

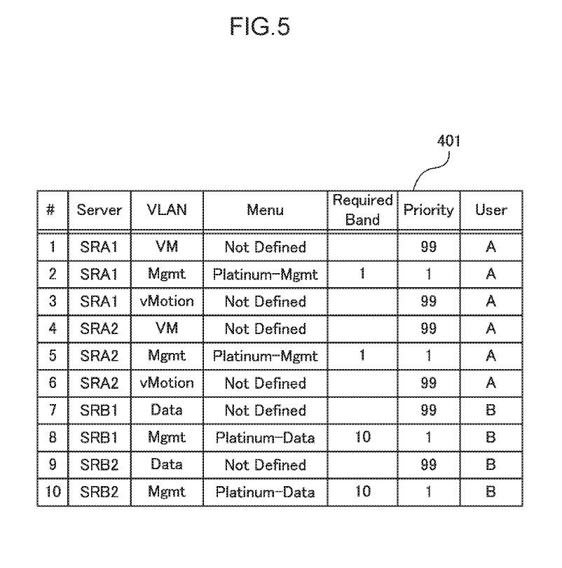

FIG. 4 is a flowchart illustrating an example of virtual network request reception processing S100 by the virtual network request receiving unit 211. As illustrated in this flowchart, the virtual network request reception processing S100 firstly, for example, copies a user request table 401 stored in the nonvolatile storage unit 203 and expands it in a memory which is the volatile storage unit 202 (S101). The user request table 401 includes columns of, for example, identifiers of the first server apparatus SRA1 to the fourth server apparatus SRB2 and a “User” column indicating an identifier of a user who is an administrator of each server apparatus as illustrated in FIG. 5. Furthermore, the user request table 401 includes columns of: an identifier of a virtual network used by each server apparatus (hereinafter also referred to as a “VLAN [Virtual Local Area Network]”); and a “Requested Communication band” which is requested by the relevant VLAN, and a “Priority” of the relevant VLAN. In this embodiment under this circumstance, the priority is expressed as a numerical value from “1” to “99” where “1” is the highest priority and “99” is the lowest priority. When the priority is “99,” it means that the relevant VLAN shares the communication band with other VLANs with the priority “99.” Furthermore, when the priority is “1,” it means that the requested communication band will be always secured. Furthermore, a “Menu” column will be explained later in detail, but it means a combination of a specified requested communication band and a specified priority. However, a VLAN with the priority “99” may not have to mean that it is shared; and the “Menu” column may not have to be included. Furthermore, the priority “1” may not have to mean that the requested communication band will be always secured.

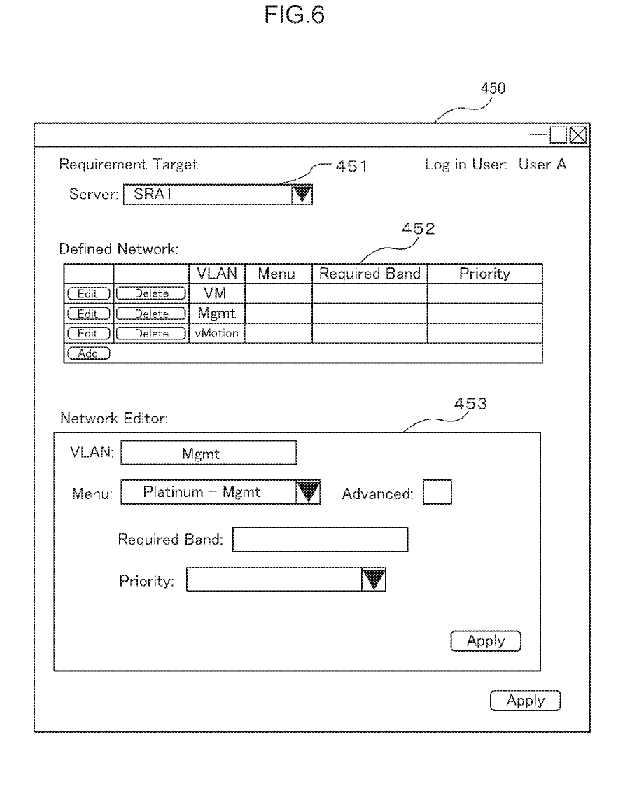

Referring back to FIG. 4, the user request table 401 which is expanded in the memory is updated based on a request regarding a virtual network(s) which is input by the user (S102). Under this circumstance, the priority “99” can be set to a virtual network(s) to which no priority is set. Values in the user request table 401 in FIG. 5 are updated values. Regarding the user's input, for example, the virtual network request receiving unit 211 may display a request input screen 450 as illustrated in FIG. 6 to allow the user who is an administrator of the relevant server apparatus to input information. For example, the request input screen 450 can be a screen which is displayed when user A who is the administrator of the first server apparatus SRA1 and the second server apparatus SRA2 logs into the inter-switch communication management apparatus 200 from the input terminal 131. When the first server apparatus SRA1 which is a terminal managed by user A himself/herself is selected in a field 451 of the request input screen 450, “VM” and “Mgmt” which are VLAN identifiers are displayed in a defined network section 452. “VM” represents a VLAN used by a virtual machine and “Mgmt” can be defined as a VLAN for communication of control data for controlling the relevant server apparatus. Under this circumstance, for example, when editing a “Mgmt” VLAN is selected, the user can designate the requested communication band and the priority for the “Mgmt” VLAN in a network editor section 453. Under this circumstance, a combination of the “Requested Communication band” and the “Priority” which are set in advance can be selected by selecting any one of listed items in the Menu.

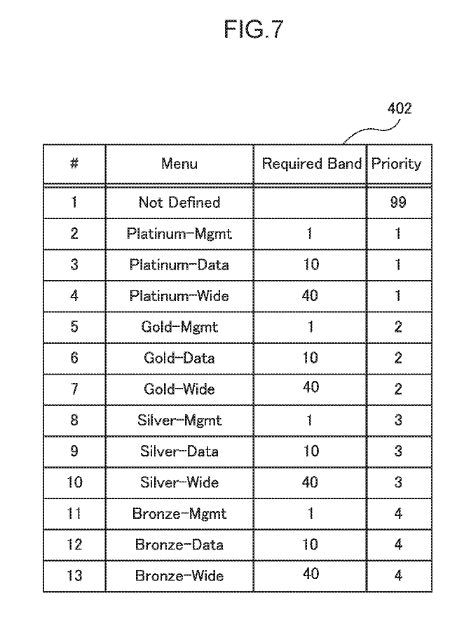

FIG. 7 is a menu definition table 402 for illustrating an example of combinations of the requested communication band and the priority which can be selected in the Menu. In this embodiment, the menu definition table 402 is composed of a total of 13 items, that is, 12 combinations which are different combinations of the priority and the requested communication band, and the priority “99” indicating that the relevant communication band is shared as illustrated in this table. The requested communication band and the priority are set by selecting any one of the Menu items in the Menu column of the request input screen 450. However, a request regarding a virtual network may be transmitted to the virtual network request receiving unit 211 without using such request input screen 450 or the Menu.

Referring back to FIG. 4, the updated information of the user request table 401 is delivered to the inter-switch communication band allocation unit 212 and the inter-switch communication band allocation unit 212 executes inter-switch communication band allocation processing S200.

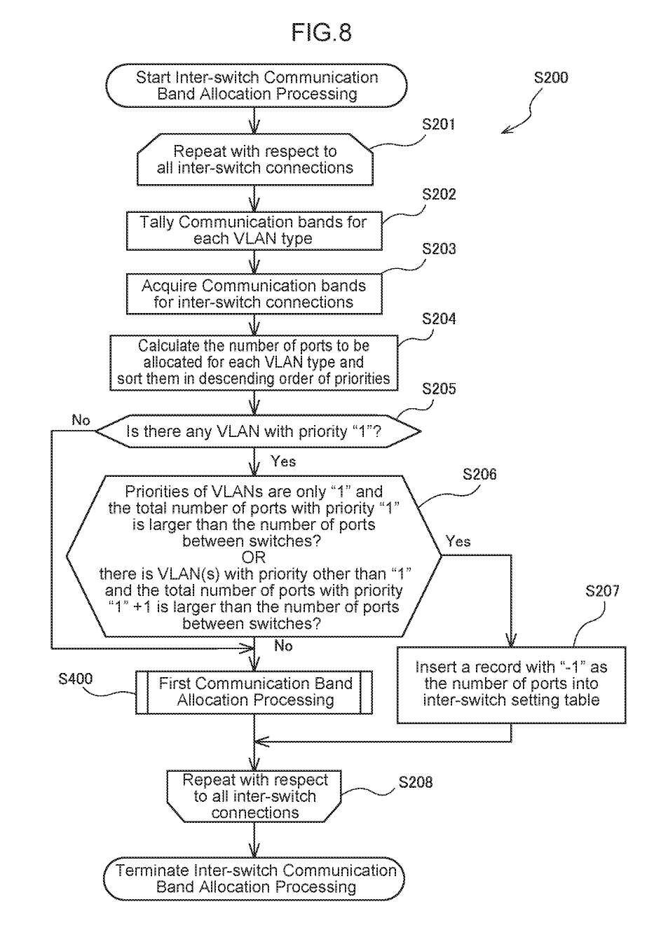

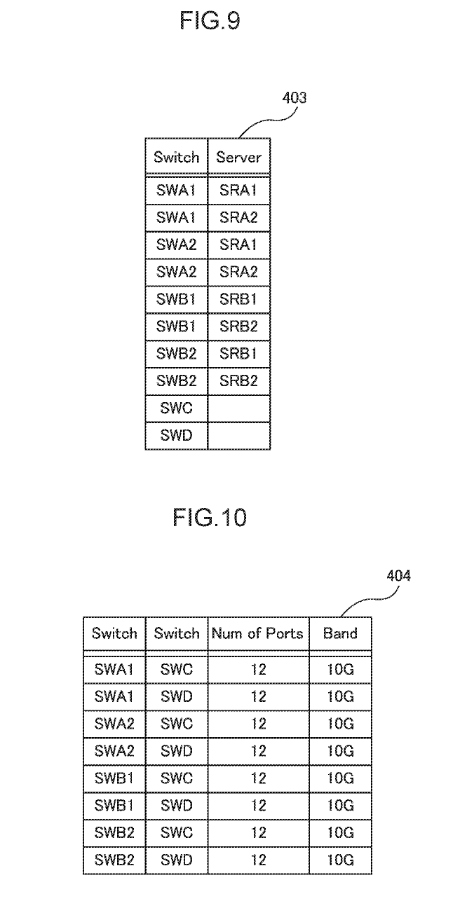

FIG. 8 is a flowchart illustrating an example of the inter-switch communication band allocation processing S200. As illustrated in this flowchart, the inter-switch communication band allocation processing S200 firstly acquires an inter-switch connection list from FIG. 10, selects one switch from that list, and acquires its communication band from “Communication band” (S201). Next, a communication band requested for each VLAN regarding the selected inter-switch connection is acquired from information of the user request table 401 (S202). Regarding this processing in step S202, for example, when the inter-switch connection between the first switch SWA1 and the fifth switch SWC is selected in step S201, server apparatuses connected to the first switch SWA1 and the fifth switch SWC are identified by referring to, for example, a switch table 403 illustrated in FIG. 9. In this case, the first server apparatus SRA1 and the second server apparatus SRA2 are identified; and furthermore, information about the first server apparatus SRA1 and the second server apparatus SRA2 is acquired from information of the user request table 401 illustrated in FIG. 5, VLANs with the same user identifier and the same VLAN name are grouped, and the requested communication bands of each group are tallied with respect to all the groups. For example, regarding FIG. 5, “Mgmt,” “VM,” and “vMotion” are respectively formed into groups and the requested communication bands of the above-mentioned groups are 2, 0, and 0, respectively.

Referring back to FIG. 8, the communication band of the selected inter-switch connection is acquired from an inter-switch port table 404 in FIG. 10 (S203). Regarding the inter-switch port table 404, a record is created for each inter-switch connection and the number of ports connecting the relevant switches and the relevant communication band are saved as illustrated in the inter-switch port table 404 in FIG. 10.

Subsequently, the number of necessary ports is calculated by using the communication band requested by each VLAN acquired in step S202 and the Communication band acquired in S201 and then is sorted according to the priority (S204). Under this circumstance, the requested communication bands of “Mgmt”, “VM,” and “vMotion” are 2, 0, and 0, respectively, in the aforementioned example, so that the number of necessary ports of “Mgmt,” “VM,” and “vMotion” is 1, 0, and 0, respectively. Regarding the priority, “Mgmt” has the highest priority “1” and “VM” and “vMotion” have the same priority “99.”

Next, whether there is any VLAN with the priority “1” or not is judged (S205). Under this circumstance, when there is a VLAN(s) with the priority “1”, the following criterion A and criterion B are judged (S206).

Criterion A: priorities of VLANs are only “1” and the total number of ports with the priority “1” is larger than the number of ports between switches.

Criterion B: there is a VLAN(s) with the priority other than “1” and the total number of ports with the priority “1”+1 is larger than the number of ports between switches.

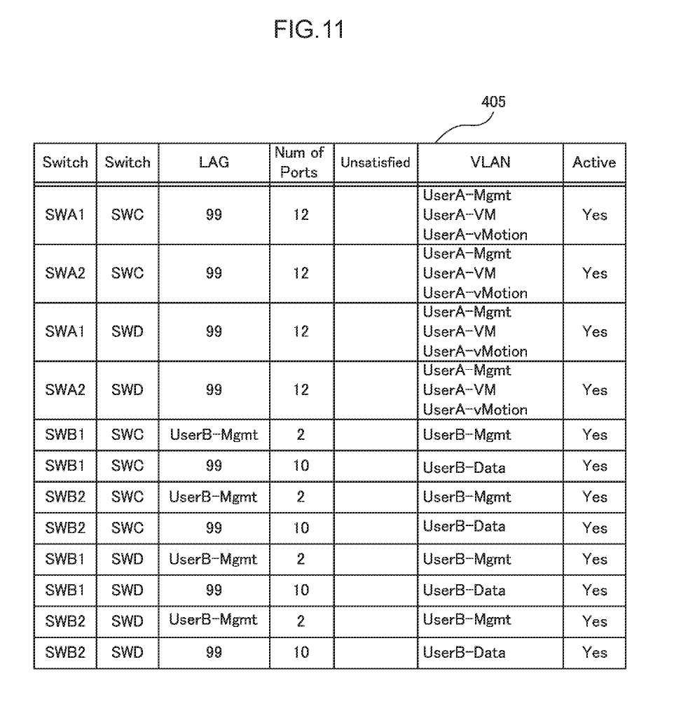

For example, in an example of user A in the user request table 401 in FIG. 5, the priorities of VLANs are not only “1,” so that a negative judgment is made regarding criterion A; and also regarding criterion B, there are VLANs with the priority which is not “1,” but the total number of ports with the priority “1”+1 is “3,” which is not larger than “12” that is the number of ports between the switches, so that a negative judgment is made. When an affirmative judgment is made regarding either criterion A or criterion B in step S206, a record “−1” is inserted into a number-of-ports column for the selected inter-switch connection in an inter-switch setting table 405 (FIG. 11) described later and related VLAN names are set to a VLAN column (S207). If there is any inter-switch connection which has not been selected yet, the processing returns to step S201 and the processing is repeated (S208). When there is no inter-switch connection which has not been selected yet, the inter-switch communication band allocation processing S200 is terminated. On the other hand, when an affirmative judgment is not made in either criterion A or criterion B in step S206 or when it is determined in step S205 that there is no VLAN with the priority “1,” the processing proceeds to first communication band allocation processing S400. Incidentally, the aforementioned criterion A and criterion B are examples and any judgment criteria other than those may be defined.

FIG. 9 and FIG. 10 show configuration information of switches, a connection relationship between a plurality of switches, and a connection relationship between switches and servers. This information may be created by the administrator or may be generated by regularly collecting information from the switches and the servers.

FIG. 11 illustrates an example of the inter-switch setting table 405. Referring to this drawing, the inter-switch setting table 405 includes: two switch identifier columns indicating which switches are relevant; an identifier column (stated as “LAG”) indicating the name of a communication band allocated to one or more VLANs; the number of allocated ports; a column (stated as “Unsatisfied”) indicating whether or not the allocated communication band is a communication band satisfying the request of the user request table 401; a column indicating identifiers of the allocated VLAN(s); and a column (stated as “Active”) indicating whether it is currently set and is in an active state or not. Under this circumstance, “99” in the LAG column means that the priority of the relevant VLAN(s) is “99.”

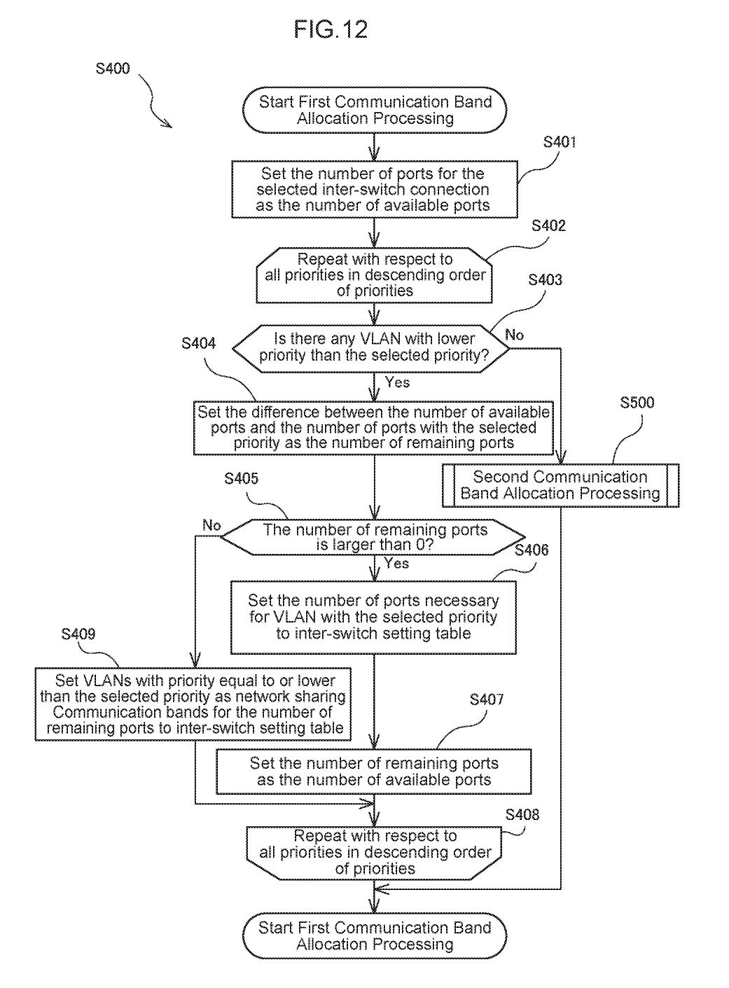

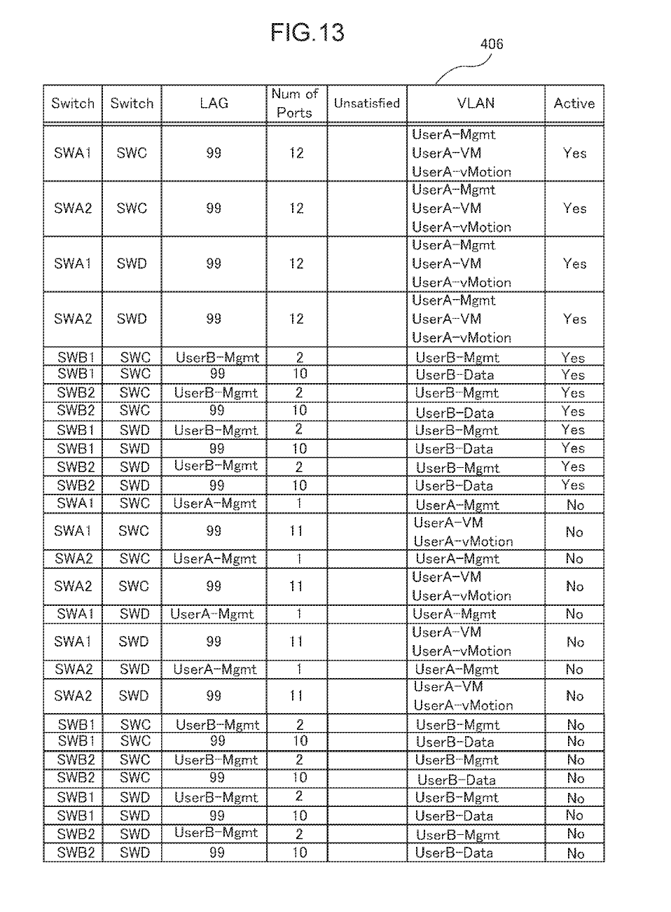

FIG. 12 is a flowchart illustrating an example of the first communication band allocation processing S400. As illustrated in this flowchart, the first communication band allocation processing S400 firstly acquires the number of ports for the selected inter-switch connection from the “Num of Ports” column in FIG. 10 and sets it as the number of available ports (S401). Regarding an example where the inter-switch connection between the first switch SWA1 and the fifth switch SWC is selected, the number of available ports is “12.” Next, as processing to be executed on all the VLANs sorted in step S204, the priority is selected in descending order of the priorities (S402); and whether or not there is any VLAN with a priority lower than (or whose value is higher than) the selected priority is judged (S403). Under this circumstance, when there is a VLAN with a priority lower than the selected priority, the difference between the number of available ports and the number of ports for the selected priority is set as the number of remaining ports (S404); and whether the number of remaining ports is larger than 0 or not is judged (S405). When the number of remaining ports is larger than 0, a new record is inserted into the inter-switch setting table 405 to set the communication band of the calculated number of necessary ports with respect to each VLAN with the selected priority and “No” is set to the Active column (S406). For example, as illustrated in an inter-switch setting table 406 in FIG. 13 in which records with “No” in their Active column are added, one port is allocated, as indicated as “User A—Mgmt” in the LAG column, to the VLAN “Mgmt” with the priority “1” with respect to between the selected first switch SWA1 and fifth switch SWC.

Referring back to FIG. 12, the number of remaining ports is set as the number of available ports (S407); and when there is any priority which has not been selected yet, the processing returns to step S402 and the processing is repeated (S408). When there is no VLAN which has not been selected, the first communication band allocation processing S400 is terminated. On the other hand, when a judgment is made in step S405 other than the judgment that the number of remaining ports is larger than 0, VLANs with the selected priority and with a priority lower than the selected priority are set, as a network sharing communication bands of the number of remaining ports, to the inter-switch setting table 405 (S409). Under this circumstance, for example, the words “or higher” may be added to the number of the selected priority in the “LAG” column of the inter-switch setting table 405, the total number of ports with the selected priority may be entered in the “Unsatisfied” column, and “No” may be entered in the “Active” column. Regarding the allocation of a virtual network(s) with the priority thus selected, if the remaining inter-switch communication bands are smaller than the communication band to be allocated, the remaining inter-switch communication bands are allocated to, and are shared by, the virtual network(s) requested with the selected priority and the priority lower than the selected priority, so that an exclusive communication band will be allocated to a virtual network with a high priority, while the shared communication band will be allocated for the request for the low priority in excess of communication band capacity; and, therefore, the communication bands of the inter-switch connections can be utilized more efficiently in accordance with the priorities. Since there is a column like the “Unsatisfied” column for identifying whether a shared virtual network which has not satisfied the user's request yet is included or not, the administrator can easily recognize that the communication band of the relevant inter-switch connection does not satisfy the request.

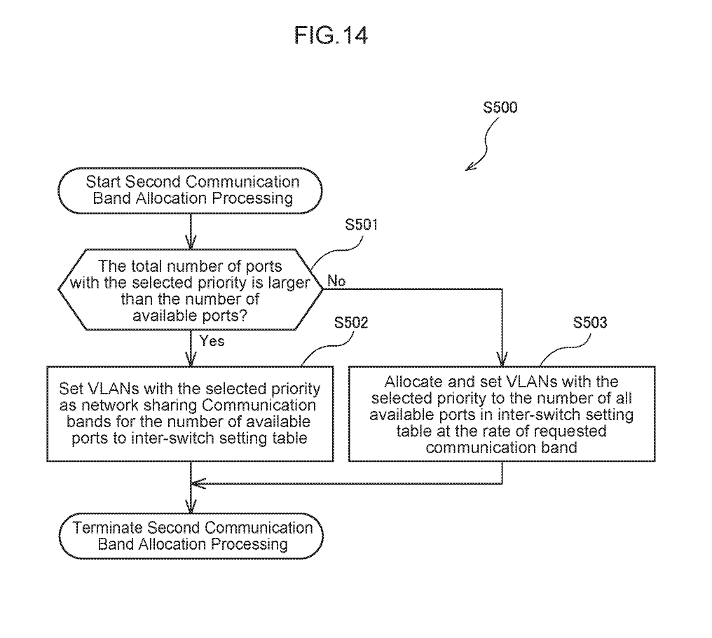

On the other hand, when there is no VLAN with the priority lower than the selected priority in step S403, the processing proceeds to second communication band allocation processing S500. FIG. 14 is a flowchart illustrating an example of the second communication band allocation processing S500. As illustrated in this flowchart, whether the total number of ports with the selected priority is larger than the number of available ports or not is judged (S501). Under this circumstance, when it is judged that the total number of ports with the selected priority is larger than the number of available ports, VLANs with the selected priority are set, as networks sharing the communication bands of the number of available ports, to the inter-switch setting table 405 (S502). For example, the total number of ports with the selected priority may be entered in the “Unsatisfied” column of the inter-switch setting table 405 and “No” may be entered in the “Active” column.

Therefore, regarding the allocation of a virtual network(s) with the selected priority, if the remaining inter-switch communication bands are smaller than the total number of ports for the virtual network(s) with the selected priority, the remaining inter-switch communication bands are allocated to, and are shared by, the virtual network(s) requested with the selected priority and the priority lower than the selected priority, so that an exclusive communication band will be allocated to a virtual network with a high priority, while the shared communication band will be allocated for the request for the low priority in excess of communication band capacity; and, therefore, the communication bands of the inter-switch connections can be utilized more efficiently in accordance with the priorities. Furthermore, since there is a column like the “Unsatisfied” column for identifying whether a shared virtual network which has not satisfied the user's request yet is included or not, the administrator can easily recognize that the communication band of the relevant inter-switch connection does not satisfy the request.

Furthermore, in a case of a judgment in step S501 other than the judgment that the total number of ports with the selected priority is larger than the number of available ports, VLANs with the selected priority are allocated and set at a rate of the requested communication band to the number of all available ports in the inter-switch setting table 405 (S503). For example, in an example of the priority “99” where the “Requested Communication band” for user A in FIG. 5 is not defined, it falls under the case of the judgment in step S501 other than the judgment that the total number of ports with the selected priority is larger than the number of available ports; and in step S503, the number of available ports can be shared and allocated. In an example where the inter-switch connection between the first switch SWA1 and the fifth switch SWC is selected as indicated as records with “99” in the LAG column and “No” in the Active column in FIG. 13, the number of ports “11” is allocated to VLANs “User A—VM” and “User A—vMotion.” Furthermore, when there is the “Requested Communication band,” the number of available ports can be allocated at a rate according to each “Requested Communication band.” Therefore, when there is no virtual network with a priority lower than the selected priority and the remaining inter-switch communication bands are equal to or more than the communication band to be allocated, all the inter-switch communication bands will be allocated at respective rates of the communication bands requested by the virtual network(s) with the selected priority. So, the communication bands of the inter-switch connections can be utilized efficiently.

When the processing in step S502 or step S503 terminates, the second communication band allocation processing S500 is terminated; and then referring back to FIG. 12, the first communication band allocation processing S400 is also terminated. Referring back to FIG. 8, if there is any inter-switch connection which has not been selected, the processing returns to step S201 and the processing is repeated (S208). If there is no inter-switch connection which has not been selected, the inter-switch communication band allocation processing S200 is terminated.

Referring back to FIG. 4, when the inter-switch communication band allocation processing S200 is terminated, whether or not any record with “−1” as the number of ports exists in the inter-switch setting table 405 is judged (S104). When the record with “−1” as the number of ports exists under this circumstance, it is determined that there are not enough available ports to satisfy the number of requested available ports and, for example, an error display is placed on the input terminal 131 (S104) and a record(s) with “No” in the Active column in the inter-switch setting table 405 is deleted (S105), thereby terminating the virtual network request reception processing S100. On the other hand, in a case of a judgment other than the judgment to determine that the record(s) with “−1” as the number of ports exists, the processing proceeds to switch setting processing S300.

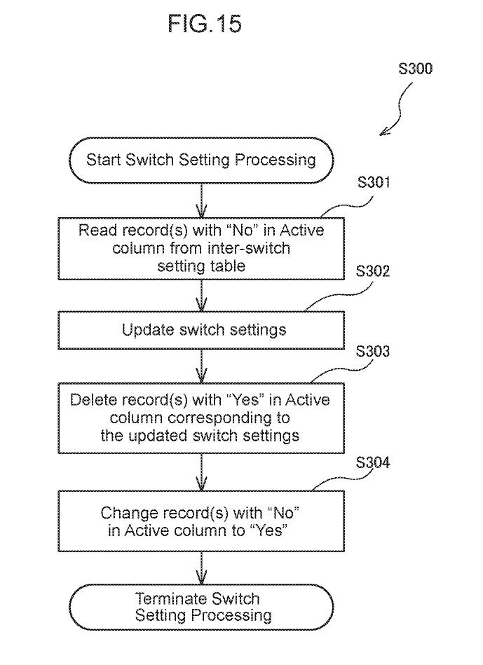

FIG. 15 is a flowchart illustrating an example of the switch setting processing S300. As illustrated in this flowchart, a record(s) with “No” in the Active column is firstly read from the inter-switch setting table 406 (S301); and the settings of each switch are updated in accordance with the content of the read record (S302). Next, a record(s) with “Yes” in the Active column corresponding to the updated inter-switch connection(s) is deleted because it has been updated (S303); and the record(s) with “No” in the Active column is changed to “Yes” (S304), thereby terminating the switch setting processing S300. Referring back to FIG. 4, the user request table 401 stored in the nonvolatile storage unit 203 is overwritten with the content of the user request table 401 updated in step S102 and then saved (S107), thereby terminating the virtual network request reception processing S100.

### (3) Advantageous Effects of this Embodiment

The inter-switch communication management apparatus 200 according to this embodiment includes: the virtual network request receiving unit 211 that receives an addition or change of a virtual network as a request with a priority; the inter-switch communication band allocation unit 212 that allocates a communication band to be preferentially used to an inter-switch communication band of a connection between two switches in descending order of the priority of virtual networks; and the switch setting unit 213 that sets the allocated communication band to the connection between the two switches. So, communication bands of the inter-switch connections can be allocated in accordance with the priorities.

### INDUSTRIAL AVAILABILITY

The present disclosure can be applied to a network system to which a plurality of computer devices are connected.

### REFERENCE SIGNS LIST

100: server network system
131: input terminal
132: network
133: network
200: inter-switch communication management apparatus
202: volatile storage unit
203: nonvolatile storage unit
204: network interface
211: virtual network request receiving unit
212: inter-switch communication band allocation unit
213: switch setting unit
401: user request table
402: menu definition table
403: switch table
404: inter-switch port table
405: inter-switch setting table
406: inter-switch setting table
450: request input screen
SRA1: first server apparatus
SRA2: second server apparatus
SRB1: third server apparatus
SRB2: fourth server apparatus
SWA1: first switch
SWA2: second switch
SWB1: third switch
SWB2: fourth switch
SWC: fifth switch
SWD: sixth switch

1. An inter-switch communication management apparatus comprising:
a virtual network request receiving unit that receives an addition or change of a virtual network as a request with a priority;
an inter-switch communication band allocation unit that allocates a communication band to be preferentially used to an inter-switch communication band of a connection between two switches in descending order of the priority of virtual networks; and
a switch setting unit that sets the allocated communication band to the connection between the two switches.

2. The inter-switch communication management apparatus according to claim 1,
wherein the inter-switch communication band allocation unit allocates a communication band to be mutually shared to a plurality of the virtual networks designated with the priority which is lowest.

3. The inter-switch communication management apparatus according to claim 1,
wherein regarding the allocation of the virtual network with the selected priority, when the inter-switch communication bands which remain are less than the communication band to be allocated, the inter-switch communication band allocation unit allocates the inter-switch communication bands which remain to, and causes the inter-switch communication bands which remain to be shared by, the virtual networks which are requested with the selected priority and the priority lower than the selected priority.

4. The inter-switch communication management apparatus according to claim 3,
further comprising an inter-switch setting table that stores an allocation status of the inter-switch communication band,
wherein the inter-switch setting table includes a column for identifying whether the virtual network which does not satisfy the request is included or not.

5. The inter-switch communication management apparatus according to claim 1,
wherein when the virtual network with the priority lower than the selected priority does not exist and the inter-switch communication bands which remain are equal to or more than the communication band to be allocated, the inter-switch communication band allocation unit allocates all the inter-switch communication bands which remain at rates according to respective sizes of communication bands requested by the virtual network with the selected priority.

6. The inter-switch communication management apparatus according to claim 1,
wherein the virtual network to which the communication band is exclusively allocated is a network which performs communication of control data for controlling a server apparatus.

7. The inter-switch communication management apparatus according to claim 1,
wherein the virtual network request receiving unit outputs a request input screen for inputting the priority and the communication band according to a type of the virtual network.

8. An inter-switch communication management method comprising:
receiving an addition or change of a virtual network as a request with a priority;
allocating a communication band to be preferentially used to an inter-switch communication band of a connection between two switches in descending order of the priority of virtual networks; and
setting the allocated communication band to the connection between the two switches.

9. A computer-readable storage medium with a program recorded there in for executing:
a virtual network request receiving step of receiving an addition or change of a virtual network as a request with a priority;
an inter-switch communication band allocation step of allocating a communication band to be preferentially used to an inter-switch communication band of a connection between two switches in descending order of the priority of virtual networks; and
a switch setting step of setting the allocated communication band to the connection between the two switches.
